(19) United States
(12) Patent Application Publication
(10) Pub. No.: US 2026/0122328 A1
(43) Pub. Date: Apr. 30, 2026

(54) CAMERA ASSEMBLY

(71) Applicant: Automated Pet Care Products, LLC D/B/A Whisker, Auburn Hills, MI (US)

(72) Inventors: Mason Newcombe, Grand Blanc, MI (US); Jason Smith, West Bloomfield, MI (US); Marcus Bosch, Belding, MI (US)

(21) Appl. No.: 19/369,998

(22) Filed: Oct. 27, 2025

Related U.S. Application Data
(60) Provisional application No. 63/711,956, filed on Oct. 25, 2024.

(51) Int. Cl. H04N 23/51; G03B 17/56

(52) U.S. Cl. CPC H04N 23/51; G03B 17/561

(57) ABSTRACT

A camera assembly having: a) a housing assembly having: i) a housing; ii) an imaging assembly within the housing; and iii) one or more metallic liners within the housing and which have a shape at least partially reciprocal with a shape of an interior of the housing; and b) a base assembly having: a magnet therein and configured to be magnetically attracted to the one or more metallic liners to removably support the housing assembly on the base assembly, wherein the magnet is retained at an angle such that an upper surface of the magnet is parallel to a tangent plane which is tangential to an outer curvature of the housing and the angle is offset from a vertical axis.

### CROSS REFERENCE TO RELATED APPLICATIONS

This application claims priority from U.S. Provisional Application No. 63/711,956, filed on Oct. 25, 2024; and which is incorporated herein by reference in their entirety for all purposes.

### FIELD

The present teachings relate to a removable mounting means for a camera assembly. The present teachings may provide for magnetic attachment of a housing assembly to a base assembly. The present teachings may provide for a housing and face assembly which provide for a unique user experience. The present teachings may provide for a mount assembly which provides flexibility in where the camera assembly is mounted to monitor one or more animals, pet health devices, and/or a surrounding environment. The present teachings may provide a camera which is sealed and suitable for being exposed to an animal's surrounding environment.

### BACKGROUND

As technology evolves, more and more pet health devices are being automated. These pet health devices may include one or more automated litter boxes, feeders, water dispensers, housings, beds, scales, and the like. These automated pet health devices may lead to more infrequent interactions of a pet owner with their animal for some of their basic needs. Examples of such automated pet health devices include U.S. Pat. Nos. 9,433,185; 11,523,586; 11,224,202 and US Publication Nos. 2025/0318499 and 2025/0234836. While the owner may interact with their pet just as frequently for play and affection, there may be less frequent cleaning of litter boxes and less frequent refilling of food and water due to the automation. Thus, there may be a desire to monitor the behavior of the animal via other means, such as visually and/or audibly.

Due to the configuration of one or more pet health devices, it may also be useful to visually monitor a device itself. This may allow for determining one or more issues or the status of the device, determine usage by an animal of the device, or both.

What is needed is a camera assembly able to monitor one or more animals, pet health devices, and/or the environment of the animal and device(s). What is needed is a camera which is suitable for being in an environment and in close proximity to animals, including being exposed to pet dander, pet fur, urine, vomit, and litter dust. What is needed is a camera which can easily adjust to various light settings in a pet's environment. What is needed is a camera assembly which is easily mountable into the environment, onto a pet health device, or both. What is needed is a camera assembly which allows for easy attachment and removal of a camera from a mount. What is needed is a camera which may be compatible with one or more methods such as disclosed in PCT Publication Nos. WO2024/196865 and WO2024/196852, which are incorporated herein by reference in their entirety for all purposes.

### SUMMARY

The present teachings provide for a camera assembly comprising: a) a housing assembly housing an imaging assembly and having one or more metallic liners; and b) a base assembly having one or more magnets therein and configured to be magnetically attracted to the one or more metallic liners to removably support the housing assembly.

The present teachings relate to a camera assembly comprising: a) a housing assembly having: i) a housing; ii) an imaging assembly within the housing; and iii) one or more metallic liners within the housing and which have a shape at least partially reciprocal with a shape of an interior of the housing; and b) a base assembly having: i) one or more magnets therein and configured to be magnetically attracted to the one or more metallic liners to removably support the housing assembly on the base assembly, wherein the magnet is retained at an angle such that an upper surface of the magnet is parallel to a tangent plane which is tangential to an outer curvature of the housing and the angle is offset from a vertical axis.

The present teachings provide for a camera assembly comprising: a) a housing assembly having: i) a housing; ii) an imaging assembly within the housing; and iii) one or more metallic liners within and biased toward a rear of the housing and which have a shape at least partially reciprocal with a shape of the housing; and b) a base assembly having: i) a base shell; ii) a friction member adapted to have the housing resting thereon and adapted to resist movement of the housing assembly relative to the base assembly; iii) a base bottom affixed to the base shell and defining an interior of the base assembly; iv) a magnet holder which projects upward from the base bottom toward the base shell and having a pair of notches formed at a rim; v) a magnet retained by the magnet holder within the pair of notches and located between the base shell and the base bottom; wherein the magnet is configured to be magnetically attracted to the one or more metallic liners to removably support the housing assembly on the base assembly; wherein the magnet has a shape which is substantially a cylinder, ring, torus, or a combination thereof; wherein the magnet is substantially coaxially aligned with the friction member; wherein the magnet is retained at an angle by the pair of notches such that an upper surface of the magnet is parallel to a tangent plane which is tangential to an outer curvature of the housing; and wherein the angle of the upper surface of the magnet is offset from a vertical axis by about 10 degrees to about 80 degrees.

The camera assembly of the present teachings may be particularly beneficial by providing a housing assembly removably affixed to a base assembly via magnetic attraction. The camera assembly of the present teachings may be relatively simple to assemble and light weight by using minimal mounting structures inside of the interior of the camera. The camera assembly of the present teachings may be suitable for being in an environment in close proximity to animals and pet health devices by being well sealed about a lens and other components. The camera assembly may easily adapt to various lighting conditions by using one or more ambient light sensors and light sources.

### BRIEF DESCRIPTION OF DRAWINGS

FIG. 1 is a perspective view of a camera assembly.

FIG. 2 is a top view of a camera assembly.

FIG. 3 is a right side view of a camera assembly.

FIG. 4 is a front view of a camera assembly.

FIG. 5 is a partially exploded view of a camera assembly showing a housing assembly distanced from a base assembly.

FIG. 6 is an exploded view of subassemblies of a camera assembly.

FIG. 7 is an exploded view of a base assembly.

FIG. 8 is a perspective view of a base assembly without a base shell.

FIG. 9 is a right side view of a base assembly without a base shell.

FIG. 10 is an exploded view of a face assembly.

FIG. 11 is a rear perspective view of a face assembly.

FIG. 12 is an exploded view of a housing assembly.

FIG. 13 is a perspective view of a housing assembly.

FIG. 14 is a perspective view of a housing assembly with an imaging assembly.

FIG. 15 is a perspective view of an imaging assembly.

FIG. 16 is an exploded view of an imaging assembly.

FIG. 17 is a partially exploded view of a camera module.

FIG. 18 is a cross-section view of a camera assembly taken along section A-A of FIG. 2.

FIG. 19 is a close-up view of the cross-section of FIG. 18.

### DETAILED DESCRIPTION

The explanations and illustrations presented herein are intended to acquaint others skilled in the art with the present teachings, its principles, and its practical application. The specific embodiments of the present teachings as set forth are not intended as being exhaustive or limiting of the present teachings. The scope of the present teachings should be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

The present teachings may relate to a camera assembly. The camera assembly may be useful in recognizing and/or monitoring one or more animals, pet health devices, environment, or any combination thereof. The camera assembly may be useful for being located within or more settings. The camera assembly may be temporarily, semi-permanently, and/or permanently affixed and/or located within a setting. A setting may include an environment in which a pet health device is located, on a pet health device, in an environment used by an animal, the like, or any combination thereof. For example, a camera assembly may be mounted to a wall in a room in which one or more pet health devices are located. As another example, a camera assembly may be mounted onto an exterior of a pet health device. A camera assembly may be located such that the camera assembly (e.g., lens) may have a line of sight onto a pet health device, an animal approaching and/or using the pet health device, a room overall, or a combination thereof.

A camera assembly may include one or more base assemblies, housing assemblies, face assemblies, imaging assemblies, the like, or a combination thereof.

A camera assembly may include a base assembly. A base assembly may function to retain the camera assembly on a surface, support a housing assembly, or both. The base assembly may provide for removable attachment from the housing assembly. The base assembly may include one or more wall mounts, base bottoms, magnets, friction members, weights, the like, or a combination thereof.

The base assembly may include a magnet. The magnet may function to attract and removably attach a housing assembly to the base assembly. The magnet may magnetically attract one or more metallic liners. The magnet may cooperate with one or more metallic liners for allowing rotation and movement of a housing assembly relative to a base assembly into various positions. The one or more magnets may have any shape suitable for being housed within a base assembly, cooperating with a housing assembly, or both. The one or more magnets may have a shape reciprocal with a shape of a friction member, mating area, or both. The one or more magnets may have a shape which is substantially a cylinder, cuboid, cube, ring, torus, sphere, half-sphere, cone, truncated cone, prism, pyramid, the like, or a combination thereof. The one or more magnets may be substantially solid or partially solid. The one or more magnets may have one or more openings therethrough (e.g., ring or torus-shaped). The one or more magnets may comprise one or more magnetic materials. One or more magnetic materials may include one or more metals which are magnetized. One or more metals may include iron, nickel, cobalt, alloys thereof, the like, or any combination. The magnet may be located in an interior or on an exterior of a base assembly. The magnet may be located between a base shell and base bottom, base shell and wall mount, or both. The magnet may be supported (e.g., retained) by a magnet holder. The magnet may be held at an angle substantially parallel to an angle of an upper surface of the base shell.

A magnet may be retained at a magnet angle. The magnet angle may refer to an angle that the magnet is retained at. The magnet angle may refer to an angle formed between an upper surface of a magnet and an axis. The axis may be the vertical axis, horizontal axis, or both. The magnet angle may refer to an angle formed between a vertical axis and the magnet surface. The magnet angle may refer to an angle opening toward an upper surface of a base shell, away from the base bottom, or both. The angle may refer to the angle closest to the upper surface of the magnet. The magnet angle may be acute, perpendicular, and/or obtuse. The magnet angle may be configured to place the magnet, upper surface of the base shell, or both at a tangent angle relative to the housing of the housing assembly. The magnet angle may be about 0 degrees or greater, about 10 degrees or greater, about 20 degrees or greater, about 30 degrees or greater, or even about 40 degrees or greater. The magnet angle may be about 90 degrees or less, about 80 degrees or less, about 70 degrees or less, or even about 60 degrees or less. The magnet angle may be about 30 degrees to about 70 degrees. An upper surface of the magnet may be substantially planar or nonplanar. An upper surface of the magnet may be substantially parallel to a tangent plane. A tangent plane may be a plane which is tangent relative to a curved surface of a housing, such as that of the housing assembly.

The base assembly may include a base bottom. The base bottom may function to be the base support of the base assembly. The base bottom may function to retain components of the base assembly. The base bottom may function to cooperate with a wall mount to allow for attachment to a secondary surface, rest on horizontal surface, or both. The base bottom may have a cross-sectional, profile shape, or both. The profile shape may refer to the shape from a top view. The profile shape may substantially be a trapezoid, circle, semi-circle, triangle, square, oval, rectangle, rhombus, the like, or a combination thereof. For example, the profile shape may be substantially trapezoidal with rounded corners. The base bottom may include one or more tab openings, feet, retention tabs, magnet holders, the like, or a combination thereof.

The base bottom may include a magnet holder. The magnet holder may function to hold the magnet, retain the magnet at the magnet angle, or both. The magnet holder may be part of the base assembly. The magnet holder may be part of or separate from the base bottom, base shell, wall mount, the like, or a combination thereof. The magnet holder may be integral or affixed to the base bottom. The magnet holder project from the base bottom toward the base shell. The magnet holder may have a shape which is substantially a cylinder, cuboid, cube, ring, torus, sphere, half-sphere, cone, truncated cone, prism, pyramid, the like, or a combination thereof. The magnet holder may have one or more indentations at its rim. The indentations may be formed as one or more angled notches. The angled notches may include two angled notches. The two angled notches may be opposite one another. The angled notches may have side walls with an angle substantially similar to the magnet angle. The angled notches may include the magnet resting therein.

The base bottom may include one or more tab openings. The one or more tab openings may cooperate with one or more tabs of one or more wall mounts. The one or more tab openings may function to receive and engage with one or more tabs. The one or more tab openings may allow for a sliding engagement, hooked engagement, or both with one or more tabs. The one or more tab openings may include a single or a plurality of tab openings. The one or more tab openings may include one or more, two or more, or even three or more tab openings. The one or more tab openings may be located about a magnet holder, within a periphery of the base bottom, or both.

The base bottom may include one or more feet. The one or more feet may allow the base bottom to rest on a surface, may engage with a wall mount, or both. The one or more feet may include one or more integrated protrusions, separate pads, or both. The one or more feet may be made of the same or a different material as the base bottom. The one or more feet may be biased toward the periphery of the base bottom. The one or more feet may be located adjacent one or more side edges, corners, or both of the profile shape of the base bottom.

The base assembly may include one or more weights. The one or more weights may function to retain the camera assembly in an upright position, balance the camera assembly, or both. The one or more weights may be located inside of the base assembly. The one or more weights may be located adjacent to a magnet holder, biased toward a front of the base assembly, biased toward a rear of the base assembly, biased to one or both sides of the base assembly, or a combination thereof. The one or more weights may be located at least partially about the magnet holder. The one or more weights may include a single or a plurality of weights.

The base assembly may include a base shell. The base shell may function to conceal the interior components of the base assembly, provide the support surface of a housing assembly, conceal a magnet, the like, or any combination thereof. The base shell may be affixed to the base bottom. The base shell may be secured to the base bottom via a snap engagement, one or more fasteners, or both. The base shell may have a rim which is substantially reciprocal with the profile shape of the base bottom. The base shell may be located over a magnet holder, magnet, or both. The base shell may have an overall shape which is substantially a pyramid, prism, cuboid, cube, cone, truncated cone, cylinder, sphere, half-sphere, the like, or any combination thereof. The base shell may appear similar to a triangular prism with one or more curved sides.

The base shell may have an upper surface. The upper surface may be the surface which interacts with a housing assembly, provides the support surface for a housing assembly, or both. The upper surface may a side of the prism shape. The upper surface may be at a same or different angle as the opposite side surface relative to a base of the prism shape. The upper surface may have a similar slope and/or angle as the magnet. The upper surface may be curved, flat, or both. The upper surface may be concave. The upper surface may be curved inward, toward an interior of the base assembly, toward the base bottom, or both. The upper surface may include a friction depression, may define a mating area, may retain a friction member, or any combination thereof.

The base assembly may include a friction depression. The friction depression may function to retain a friction member, define a mating area, or both. A friction depression may be formed in one or more exterior surfaces of a base assembly. A friction depression may be formed in an upper surface of a base shell. A friction depression may be formed as a groove a surface. A friction depression may have a shape substantially reciprocal with the shape of a friction member. A three-dimensional shape of a friction depression may substantially be a ring, torus, cylinder, half-sphere, cuboid, cube, cone, truncated cone, prism, pyramid, sphere, the like, or a combination thereof. The friction depression may include one or more fastener openings. The fastener openings may be formed in the same surface as the friction depression. The fastener openings may be formed in the upper surface of the base shell. The fastener openings may receive one or more fasteners or other attachment mechanisms associated with a friction member. For example, one or more posts or pins integral with a bottom surface of a friction member may be inserted into the one or more fastener openings. There may be a friction and/or snap fit between the one or more friction openings and the one or more fasteners. An area within the friction depression may be referred to as the mating area. The friction depression may be located above a magnet. The friction depression may be aligned (e.g., centered, concentric) with a magnet.

The base assembly may include a friction member. A friction member may cooperate with a housing assembly when supported by the base assembly. A friction member may provide a surface for the housing assembly to rest on. A friction member may resist movement of the housing assembly relative to the base assembly, such as sagging or other movement of the housing due to gravity. A friction member may provide a protective surface for the repeated movement of the housing assembly relative to the base assembly. A friction member may be located on one or more exterior surfaces of a base assembly. A friction member may be located on the upper surface of a base shell. A friction member may be located at least partially in a friction depression. A three-dimensional shape of a friction depression may substantially be a ring, torus, cylinder, half-sphere, cuboid, cube, cone, truncated cone, prism, pyramid, sphere, the like, or a combination thereof. A ring or torus-shaped friction member may be referred to as a friction ring. The friction member may define the mating area. The mating area may be a void, hollow area, concave depression, and/or the like formed in the friction member. The mating area may have a shape and/or contour non-complementary, not reciprocal, reciprocal, or a combination thereof to curvature of an exterior of the housing. The mating area may have limited contact with the housing. The mating area may only contact a point or small surface of the housing or not have contact at all with the housing. The mating area may have substantially tangential contact with an exterior of the housing. The friction member may have more contact (e.g., surface area) with the housing than the mating area within the friction member. The friction member may be aligned (e.g., concentric and/or coaxial) with a magnet, friction depression, or both. A friction member may include one or more fasteners. The one or more fasteners may aid in retaining the friction member. The one or more fasteners may include one or more protrusions (e.g., posts, tabs, pins) extending from a surface of the friction member. The one or more fasteners may project from a bottom surface of the friction member. The one or more fasteners may be located within one or more fastener openings of a friction depression. The friction member may be comprised of a material having a same or greater friction coefficient as an upper surface of a base shell. The friction member may be comprised of one or more rubbers, polymers, or both. The friction member may be rubber, silicone rubber, thermoplastic elastomer (TPE), thermoplastic polyurethane (TPU), thermoplastic copolyester (TPC), the like, or any combination thereof.

The base assembly may include one or more wall mounts. A wall mount may function adapt the camera assembly for mounting (e.g., being affixed) to a surface as opposed resting on a surface. A wall mount may provide for attachment of itself to a wall while allowing for direct removable engagement with one or more components of the base assembly. A wall mount may be in a sliding engagement with the base bottom. A wall mount may include one or more fastener openings. One or more fastener openings may allow for one or more fasteners (e.g., threaded) to pass therethrough and affix the wall mount to a surface (e.g., wall). A wall mount may include one or more tabs. The one or more tabs may function to enter into and engage with one or more tab openings of a base bottom. The one or more tabs may function and/or appear like hooks. The one or more tabs may extend from an upper surface of the wall mount toward a base bottom. The all mount may include a same number of tabs as a base bottom includes tab openings. A wall mount may include one or more foot depressions. One or more foot depressions may be one or more depressions in which one or more feet of a base bottom may reside. One or more foot depressions may allow for a base bottom to fully rest on the wall mount without a gap due to the feet.

The camera assembly may include a housing assembly. A housing assembly may function to house one or more components of the camera assembly. A housing assembly may house an imaging assembly, face assembly, or both. A housing assembly may rest on a base assembly. A housing assembly may be removably affixed to a base assembly. A housing assembly may be magnetically attracted and attached to the base assembly. A housing assembly may include one or more metallic liners, openings, buttons, memory storage covers, the like, or any combination thereof.

A housing assembly may include one or more housings. A housing may function to house one or more components of the housing assembly. A housing may have any size and/or shape suitable for housing the components. A housing may have a three-dimensional shape which is substantially a half-capsule, half-sphere, pyramid, cube, cuboid, prism, cone, cylinder, sphere, the like, or any combination thereof. For example, a housing may have a three-dimensional shape which is substantially a half-capsule (e.g., bullet shaped). A housing may include a substantially closed end, an open end, or both. An open end may be at a wider end of the housing. An open end may define a rim about the opening. A closed end may be at a curved end of the housing. The housing may include one or more speaker openings. The speaker openings may include a plurality of openings. The plurality of openings may be arranged in a plurality of arrays. The speaker openings may be located on a side and/or rear of the housing. The speaker openings may be biased toward a side of the housing. The speaker openings may be aligned with a speaker inside of the housing.

A housing assembly may include one or more metallic liners. A metallic liner may function to cooperate with one or more magnets, a base assembly, or both. A metallic liner may function to be magnetically attracted by a magnet of a base assembly. A metallic liner may have any size and/or shape suitable for cooperating with the magnet and being housed within the housing. The metallic liner may be located inside and/or outside of the housing. The metallic liner may form part of the housing or lie adjacent to the housing. The metallic liner may have a shape at least partially reciprocal with a shape of the housing. The metallic liner may have a shape reciprocal with a rear and/or bottom of a housing. A metallic liner may have a shape which is substantially a partial capsule, partial sphere, partial cube, partial cuboid, partial cylinder, partial cone, the like, or any combination thereof. A metallic liner may have a shape which is roughly about a quarter of a capsule or a quarter of a sphere. The metallic liner(s) may have a surface area greater than that of the magnet. The metallic liner may be configured to allow rotation of the housing assembly relative to the base assembly. The metallic liner may be configured to be attracted to the magnet across its surface area to provide for rotation and movement of the housing assembly. The metallic liner may be located within the housing such as to allow for upward (e.g. tilting front up), downward (e.g., tilting front down), and/or sideways movement (e.g., turning front left or right) of the housing assembly relative to the base assembly. The metallic liner may comprise one or more metals. The one or more metals may include one or more ferromagnetic metals. The one or more metals may include iron, nickel, cobalt, gadolinium dysprosium, alloys thereof such as steel, the like, or a combination thereof. The one or more metallic liners may include a single or a plurality of metallic liners. The one or more metallic liners may include two or more metallic liners cooperating together to form a shape reciprocal with a portion of the housing.

A housing assembly may include one or more openings. The one or more openings may function to receive one or more other components that cooperate with the camera assembly. The one or more openings may receive and/or house one or more buttons, memory storage, power plugs, or bother. The one or more openings may be formed in the housing. The one or more openings may provide access from the exterior to the interior of the housing. One or more openings may be formed toward a rear of the housing. One or more openings may be forward toward a front and/or bottom of a housing.

A housing assembly may include one or more buttons. One or more buttons may function to generate one or more functions of the camera assembly. One or more buttons may include a reset button. The one or more buttons may be in electrical communication with one or more components of one or more circuit boards.

The camera assembly may include one or more face assemblies. The face assembly may function to conceal an interior of the camera assembly. The face assembly may cooperate with housing assembly, imaging assembly, or both. The face assembly may conceal the interior of the housing assembly. The face assembly may be retained on and/or in the housing assembly. The face assembly may be partially attached to an imaging assembly. A face assembly may include one or more covers, seals, seal brackets, adhesives, the like, or any combination thereof.

The face assembly may include a cover. A cover may function as the face of a camera assembly, may support a lens, may provide one or more openings for components of an imaging assembly, close off a housing, the like, or a combination thereof. A cover may be located at a front of a housing. A cover may be partially located in or about a housing. A cover may have a snap engagement at front rim of a housing. A cover may be convex, concave, planar, or a combination thereof. A cover may be convex and bow out from its outer periphery toward a lens opening, center, or both. A cover may include one or more attachment and/or alignment features. The attachment features may include posts. The posts may be received in one or more openings of a mounting bracket. A cover may have any size and/or shape suitable for cooperating with a housing assembly. A cover may have a cross-sectional and/or two-dimensional shape reciprocal with cross-sectional shape of a housing. A cover may have a shape reciprocal with a rim of the housing.

A cover may include one or more openings. One or more openings may function to house one or more components, allow one or more components to pass through, allow one or more components to transmit and/or receive light and/or sound, or a combination thereof. One or more openings may include one or more les openings, sensor openings, light openings, microphone openings, the like, or a combination thereof. One or more openings may be aligned with their respective components. A lens opening may be centered or off-center on the cover. A lens opening may receive a lens, seal, or both therethrough. One or more sensor openings may be aligned with one or more sensors. One or more sensor openings may be located adjacent to the lens opening. One or more sensor openings may be located between a lens opening and a bottom, top, and/or side of a cover. One or more sensor openings may be located between a lens opening and a light opening. One or more light openings may be aligned with one or more light sources. One or more light openings may be located between a lens opening and a bottom, top, and/or side of a cover. One or more sensor openings may be located between a sensor opening and the periphery of the cover. One or more microphone openings may be aligned with one or more microphones. One or more microphone openings may be located between a lens opening and a bottom, top, and/or side of a cover. One or more microphone openings may be located generally between one or more sensor openings and one or more light openings.

A face assembly may include one or more seals. A seal may function to seal about a lens, between a lens and a cover, or both. A seal may function to seal the interior of the camera assembly. A seal may be beneficial in a camera used in a setting with one or more animals and pet health devices. Litter dust, pet dander, pet fur, pet urine, pet vomit, and/or the like are all possible contaminants which have the potential to damage functionality of the camera. A seal may be any suitable type of seal. The seal may include a gasket, O-ring, foam, adhesive, the like, or a combination thereof. The seal may be located about a lens, inside a lens opening, or both. The seal may extend from a front to a rear of a cover through a lens opening. A seal may be held in place by a seal bracket. A seal bracket may be affixed to the cover. A seal bracket may be fastened to a rear of the cover.

A face assembly may include one or more adhesives. An adhesive may function to retain the cover to a housing. An adhesive may be a permanent or temporary adhesive. An adhesive may include a tape, glue, foam, the like, or a combination thereof. An adhesive may be located on a rear of a cover. An adhesive may be located adjacent to the periphery of the cover. An adhesive may be located between a periphery and lens opening of a cover.

The camera assembly may include one or more imaging assemblies. One or more imaging assemblies may function to capture images of one or more animals, pet health devices, and/or an ambient environment. One or more imaging assemblies may function to place a camera module within a housing assembly. One or more imaging assemblies may provide the main camera functionality of the camera assembly. One or more imaging assemblies may include one or more mounting brackets, camera modules, transmitters, sensors, light sources, audible receivers and/or detectors, the like, or a combination thereof.

The imaging assembly may include one or more mounting brackets. A mounting bracket may function to support one or more components of the imaging assembly, retain the imaging assembly inside of the housing assembly, align components of imaging assembly with one or more openings of a face assembly, the like, or a combination thereof. A mounting bracket may include a single or a plurality of mounting brackets. A mounting bracket may have any suitable shape and/or size for retaining one or more components inside of a housing. A mounting bracket may have an outer peripheral shape which is reciprocal with or dissimilar from the interior shape of a housing. A mounting bracket may have an exterior cross-sectional shape which is substantially a circle, oval, square, rectangle, triangle, polygon, the like, or any combination thereof. For example, the mounting bracket may be substantially circular or ovular to match with a housing having a three-dimensional shape which is substantially a partial capsule or sphere.

The mounting bracket may have one or more attachment features. The one or more attachment features may function to affix the mounting bracket to the housing. One or more attachment features may include one or more snaps, tabs, posts, fasteners, the like, or a combination thereof. One or more attachment features may be located on the front, rear, and/or side of the mounting bracket. The one or more attachment features may be located about a void of the mounting bracket. The one or more attachment features may be located on a front and/or rear and biased toward the outer side of the mounting bracket. One or more attachment features may extend away from the front of the camera assembly, toward the rear of the camera assembly, into the housing, or a combination thereof.

The mounting bracket may have one or more voids. The void may function to reduce the overall weight of the mounting bracket, allow for components to past through the mounting bracket, allow components to extend from an interior of the housing assembly to the face assembly, the like, or any combination thereof. The void may be substantially centered or off-center to the mounting bracket. The void may have any cross-sectional shape. The void may have a cross-sectional shape which is one or more typical shapes including a circle, oval, square, rectangle, triangle, polygon, the like, or any combination thereof. The void may have an irregular cross-sectional shape which has one or more projections extending from the center. The void may have a cross-sectional shape which is irregular and forms a shape similar to a cross, star, the like, or a combination thereof.

The mounting bracket may include a supportive surface. A supportive surface may function to support one or more components of the imaging assembly. A supportive surface may function to support one or more transmitters. A supportive surface may function as a shelf A supportive surface project from a front, rear, and/or side of the mounting bracket. A supportive surface may project above, below, or to a side of the void. A supportive surface may project toward a rear, front, or side of the camera assembly. For example, a supportive surface may project from the rear of the mounting bracket and be located above the void. The supportive surface may be substantially planar or nonplanar.

The imaging assembly may include one or more camera modules (e.g., cameras). One or more camera modules may include one or more image sensors. The one or more camera modules may be suitable for capturing one or more videos, images, frames, the like, or any combination thereof. The one or more camera modules may be affixed to the mounting bracket, housing, face assembly, or a combination thereof. The one or more cameras may be capable of capturing static images, video recordings, or both at resolutions of about 480 pixels or greater, 640 pixels or greater, 720 pixels or greater, or even 1080 pixels or greater. The one or more cameras may be able to capture video recordings at a frame rate of about 25 frames per second or greater, about 30 frames per second or greater, about 60 frames per second or greater, or even 90 frames per second or greater. An exemplary camera for use with the visual monitoring device may include the SainSmart IMX219 Camera Module with an 8MP sensor and 160-degree field of vision, the camera module and its specifications are incorporated herein by reference for all purposes. A camera module may include one or more lenses, image processing units, memory, transmitters, circuit boards, the like, or a combination thereof. The camera module may include or be in electrical communication with one or more sensors, light sources, microphones, speakers, the like, or a combination thereof.

One or more camera modules may include one or more lenses. The one or more lenses may have a standard angle and/or wide-angle lens (e.g., viewing angle of 150 degrees or greater). One or more lenses may be center or off-center relative to the housing, mounting bracket, cover, or a combination thereof. One or more lenses may pass through one or more voids, openings, or both. One or more lenses may extend through a void of the mounting bracket. One or more lenses may reside in a lens opening of a cover. One or more lenses may have one or more seals located about its exterior. A seal may be located between a lens and a lens opening of a cover.

One or more camera modules may include one or more image processing units. One or more image processing units may function to receive, process, transmit image data, or any combination thereof, store image data; or both. The one or more image processing units may include one or more processors, memory storage devices, circuit boards, the like, or any combination thereof. The one or more image processing units may include one or more central processing units, graphics processing units, memory mediums, storage mediums, the like, or any combination thereof. The one or more image processing units may include an electronic circuit board or similar. The electronic circuit board may house and place one or more processing units and memory storage devices in communication with one another. The electronic circuit board may be in communication with one or more cameras, power supply sources, network connections, the like, or any combination thereof. The electronic circuit board may be located within a housing. The electronic circuit board may be mounted to the mounting bracket. The electronic circuit board may be perpendicular, parallel, or an angle therebetween relative to a longitudinal axis of a housing.

The imaging assembly may include one or more communication modules (e.g., transmitter). The one or more communication modules may allow for the one or more devices to receive and/or transmit one or more signals from one or more computing devices, be integrated into a network, or both. The one or more communication modules may have any configuration which may allow for one or more data signals from one or more controllers to be relayed to one or more other controllers, communication modules, communication hubs, networks, computing devices, processors, the like, or any combination thereof located external of camera assembly. The one or more communication modules may include one or more wired communication modules, wireless communication modules, or both. A wireless communication module may include any module capable of transmitting and/or receiving one or more data signals via a wireless connection. One or more wireless communication modules may communicate via one or more networks via a wireless connection. One or more wireless communication modules may include a Wi-Fi transmitter, a Bluetooth transmitter, an infrared transmitter, a radio frequency transmitter, an IEEE 802.15.4 compliant transmitter, the like, or any combination thereof. A Wi-Fi transmitter may be any transmitter complaint with IEEE 802.11. A communication module may be single-band, multi-band (e.g., dual-band), or both. A communication module may operate at 2.4 Ghz, 5 Ghz, the like, or a combination thereof. A communication module may communicate with one or more other communication modules, computing devices, processors, or any combination thereof directly; via one or more communication hubs, networks, or both; via one or more interaction interfaces; or any combination thereof.

The camera assembly may include one or more light sensors. One or more light sensors may function to detect lighting conditions in the ambient environment. One or more light sensors may function to detect if ambient light is sufficiently dim to activate a light source. One or more light sensors may include one or more ambient light sensors. One or more ambient light sensors may include one or more photodetectors, amplifiers, or both. One or more ambient light sensors may include one or more phototransistors, photodiodes, photonic integrated circuits, the like, or a combination thereof. One or more light sensors may be mounted on the same or different circuit board as one or more components of an imaging assembly. One or more light sensors may be aligned with one or more openings of a face assembly. One or more light sensors may be aligned with a sensor opening of a cover.

The camera assembly may include one or more light sources. One or more light sources may function to illuminate an image. Sufficient lighting may be critical in capturing detailed features of an animal to provide for visual recognition of an animal's identity, detailed features of a pet health device to determine a specific status of the device, or both. One or more light sources may be activated based on an ambient light level being detected. One or more light sources may include one or more light emitting diodes (LED). One or more light sources may be mounted on the same or different circuit board as one or more components of an imaging assembly. One or more light sources may be mounted on the same or different circuit board as a light sensor. One or more light sources may be aligned with one or more openings of a face assembly. One or more light sensors may be aligned with a light opening of a cover.

The camera assembly may include one or more audible receivers and/or transmitters. One or more audible receivers may function to receive and aid in recording of sound detected by the camera assembly. One or more audible transmitters may function to relay one or more sounds into the environment of the camera assembly. One or more audible receivers and/or transmitters may include one or more microphones, speakers, or both. One or more audible receivers and/or transmitters may be mounted into an interior and/or exterior of a housing assembly, face assembly, or both. One or more speakers may be mounted in an interior of a housing. One or more speakers may be mounted adjacent to one or more speaker openings. One or more speakers may be mounted via one or more speaker brackets. One or more microphones may be mounted adjacent to one or more microphone openings. One or more microphones may be mounted

### Illustrative Examples

Any features described herein may be combined or used in lieu of one or more other features as described herein. Elements shown in one illustrative example may be incorporated in another illustrative example.

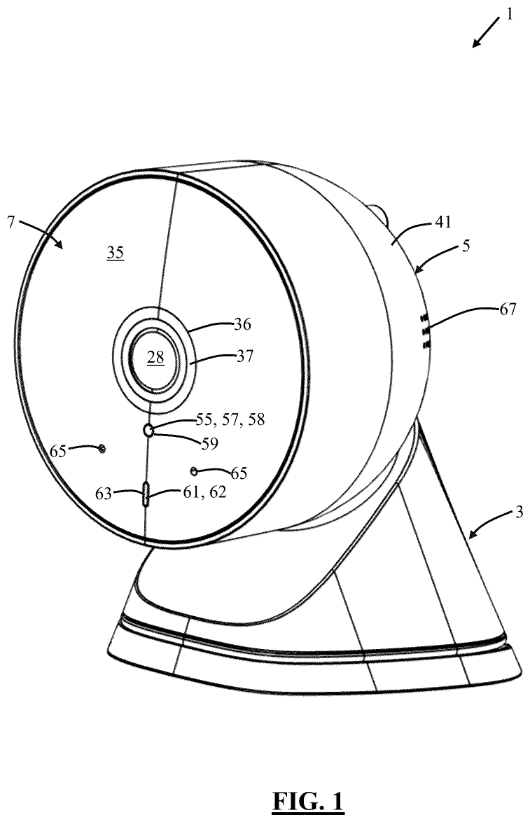

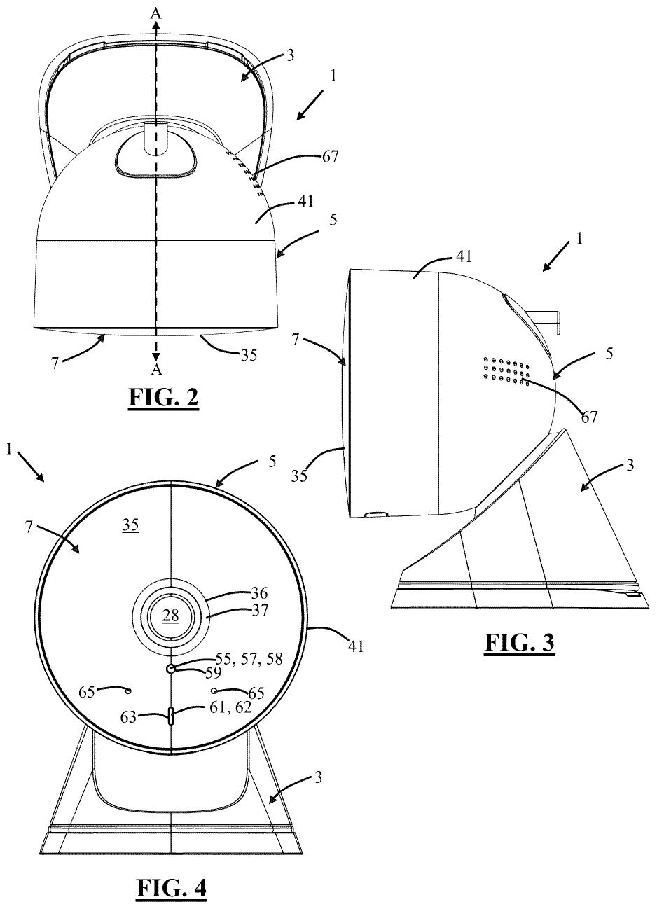

FIGS. 1-4 illustrates a camera assembly 1. The camera assembly 1 includes a housing assembly 5. The housing assembly 5 includes a housing 41. The housing 41 includes a plurality of speaker openings 67 formed therein. The speaker openings 67 are formed on a side of the housing 41 and/or biased toward a rear of the housing 41. The housing assembly 5 supports a face assembly 7. The housing assembly 5 is removably mounted to a base assembly 3. The camera assembly 1 includes a lens 28. The lens 28 is located within a lens opening 36 of a cover 35. The cover 35 is substantially convex and curves away from the housing 41. A seal 37 seals lens opening 36 about the lens 28. Located below the lens 28 is a sensor 55. The sensor 55 may be a light sensor 57, such as an ambient light sensor 58. The sensor 55 is located within a sensor opening 59 of the cover 35. Located below the lens 28 is a light source 61. The light source 61 is located within a light opening 63 of the cover 35. The cover 35 also includes one or more microphone openings 65.

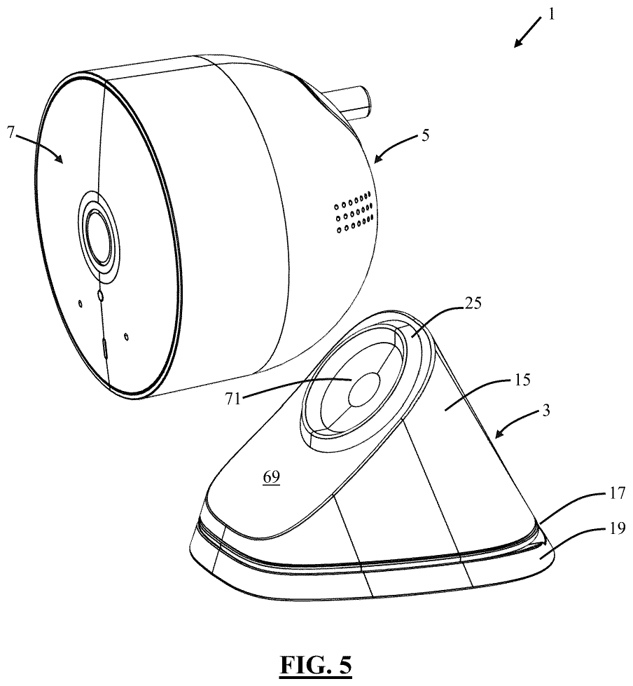

FIG. 5 illustrates the housing assembly 5 removed from the base assembly 3. The base assembly 3 and housing assembly 5 are configured to be attracted to one another for removable attachment. The base assembly 3 includes a base shell 15. The base shell 15 is supported by a base bottom 17. The base bottom 17 may be engaged with a wall mount 19. The base assembly 3 includes a friction ring 25. The friction ring 25 is located on an upper surface 69 of the base shell 15. The friction ring 25 forms a mating area 71. The housing 41 rests within the mating area 71.

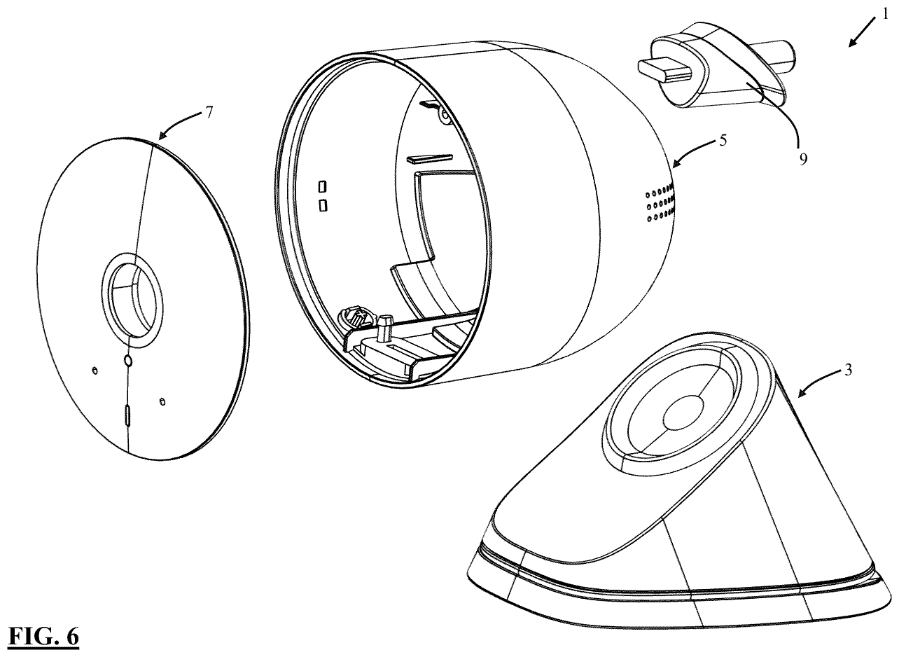

FIG. 6 illustrates an exploded view of subassemblies of the camera assembly 1. The camera assembly 1 includes a housing assembly 5. The housing assembly 5 supports a face assembly 7. The housing assembly 5 is removably mounted to a base assembly 3. A power adapter 9 is insertable into the housing assembly 5. Not shown is an imaging assembly 8 (not shown) which is located within the housing assembly 5 and concealed by the face assembly 7.

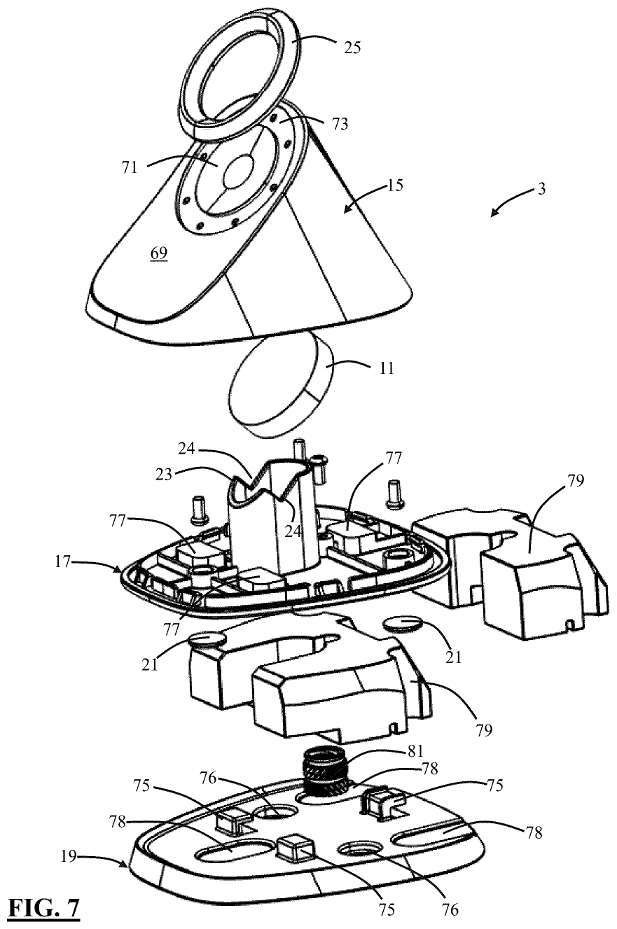

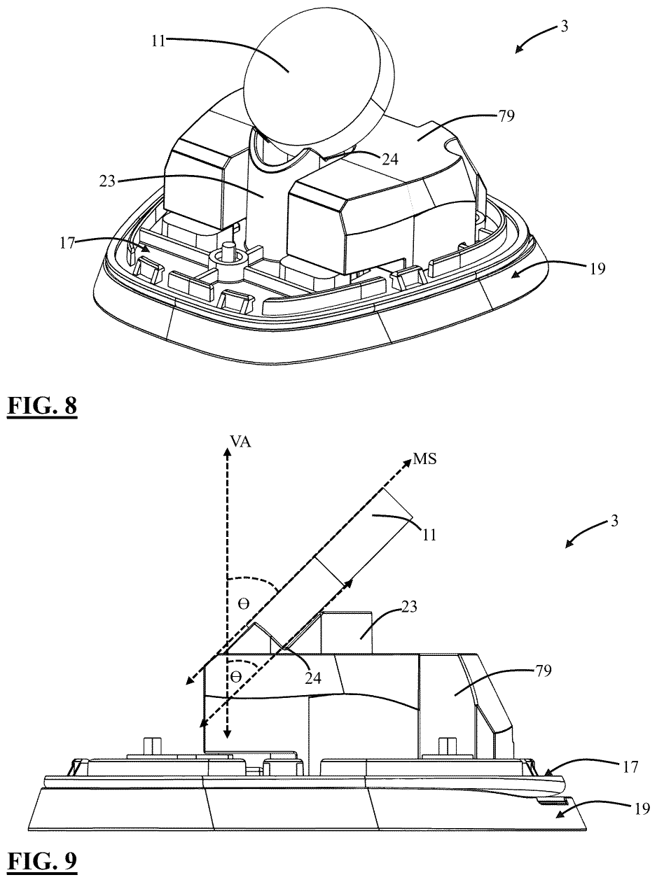

FIGS. 7-9 illustrate a base assembly 3 with FIGS. 8-9 having a base shell 15 removed. The base assembly 3 includes a magnet 11. The magnet 11 is in a form of a disc. The magnet 11 is covered by a base shell 15. The base shell 15 includes a friction depression 73. The friction depression 73 is formed in the upper surface 69. The friction depression 73 has a shape reciprocal with a friction ring 25. The base shell 15 is affixed to a base bottom 17. The base bottom 17 includes a magnet holder 23. The magnet holder 23 supports the magnet 11 directly under the base shell 15. The magnet holder 23 includes a pair of notches 24. The notches 24 are formed in a rim of the magnet holder 23. The magnet 11 is located under the mating area 71. The base bottom 17 includes one or more feet 21. The base bottom 17 is removably affixed to a wall mount 19. The wall mount 19 includes one or more tabs 75. The one or more tabs 75 slidably engage with one or more tab openings 77 of the base bottom 17. The wall mount 19 includes one or more foot depressions 78. The one or more foot depressions 78 have the feet 21 retained therein. The wall mount 19 includes one or more fastener openings 76. Also located within the base assembly 5 are one or more weights 79. The one or more weights 79 rest atop the base bottom 17 and are located at least partially about the magnet holder 23. Affixed to the base assembly 3 is a mount adapter 81. The mounter adapter 81 has a threaded interior configured to cooperate with any standard camera mounting fastener.

FIG. 9 illustrates a magnet angle θ. The magnet angle θ is formed between a vertical axis VA and a magnet surface MS of the magnet 11 facing upward (e.g., toward the upper surface 25 (not shown) of the base shell 15). The upper surface 69 (not shown) of the base shell 15 may have a substantially similar slop angle as the magnet angle (e.g., upper surface 69 substantially parallel to magnet surface MS). The magnet angle θ is formed by the angle at which the magnet 11 rests and/or is supported by the magnet holder 23. The magnet holder 23 includes one or more notches 24 which retain the magnet 11. The one or more notches 24 may have one or more walls or edges which slope at the same angle as the magnet angle θ.

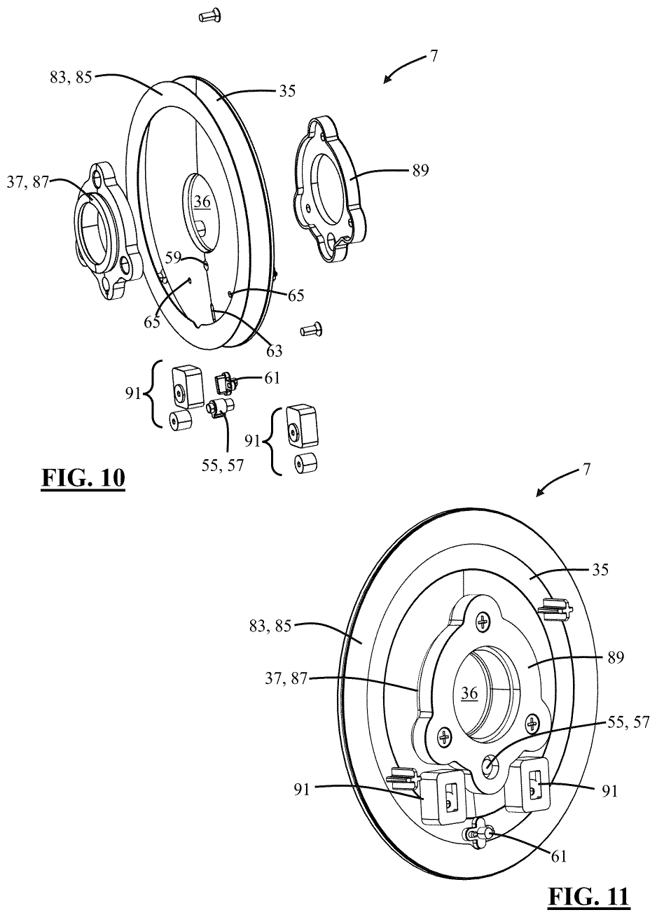

FIGS. 10-11 show a face assembly 7. The face assembly 7 includes a cover 35. The cover 35 includes a lens opening 36. The cover 35 includes a sensor opening 59. The cover 35 includes two microphone openings 65. The cover 35 includes a light opening 63. The face assembly 7 includes an adhesive 83. The adhesive 83 may be in the form of a tape 85. The adhesive 83 is located on a back surface of the cover 35. The adhesive 83 is located within the outer periphery of the cover 35. The adhesive 83 is located about the lens opening 36, sensor opening 59, microphone opening(s) 65, and/or light opening 63. In such a manner the adhesive 83 may not obstruct the one or more openings forms in the cover 35. The face assembly 7 includes a seal 37. The seal 37 is in the form of a gasket 87. The seal 37 is held in place by a seal bracket 89. The face assembly 7 may include or be affixed to one or more microphones 91. Affixed to a rear of the cover 35 is a light source 61. Affixed to a rear of the cover 35 is a sensor 55, such as a light sensor 57.

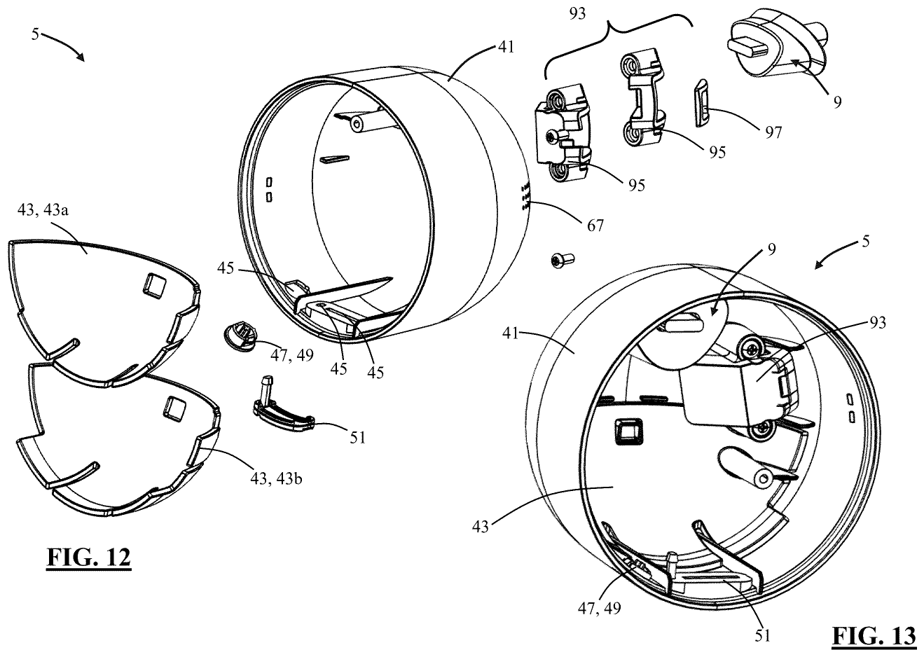

FIGS. 12-13 show a housing assembly 5 and the components therein. The housing assembly 5 includes a housing 41. Located within the housing 41 is a metallic liner 43. The metallic liner 43 may be comprised of one or more ferromagnetic metals such as to be attracted by a magnet 11 (not shown). The metallic liner 43 may include a single liner 43 or a plurality of liners 43, such as a first and second liner 43a, 43b. The housing 41 includes a plurality of openings 45. One opening 45 allows for a button 47 to be located therethrough. The button 47 may be a reset button 49. Another opening 45 provides for a memory card cover 51 (e.g., SD Card cover). Inside of the housing 41 is a speaker 93. The speaker 93 is aligned with the speaker openings 67 of the housing 41. The speaker 93 includes one or more speaker brackets 95 and foam 97. Removably inserted into the housing 41 is a power adapter 9.

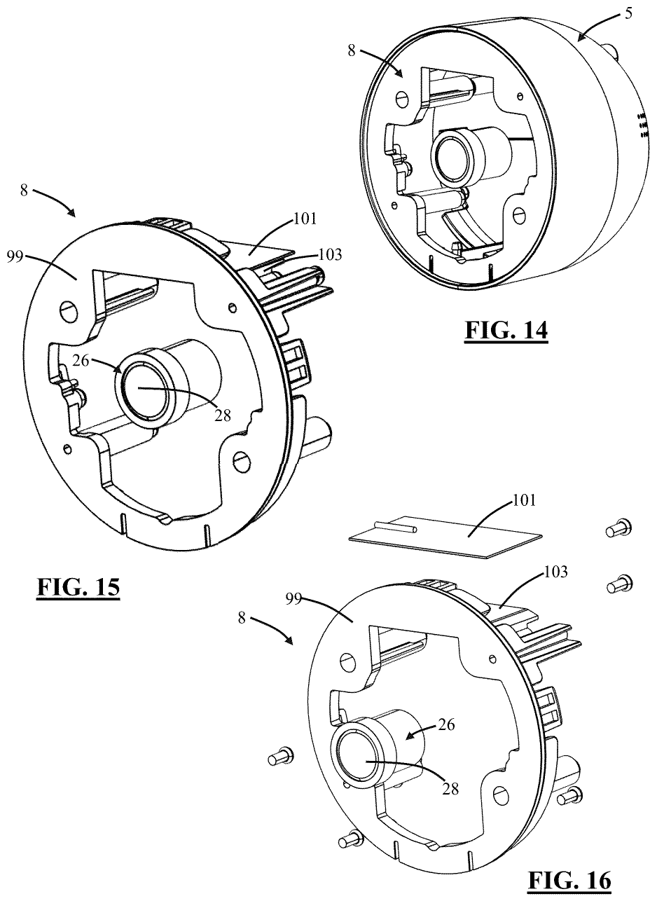

FIG. 14 shows an imaging assembly 8 within the housing assembly 5. The imaging assembly 8 may be engaged with interior attachment components of the housing assembly 5.

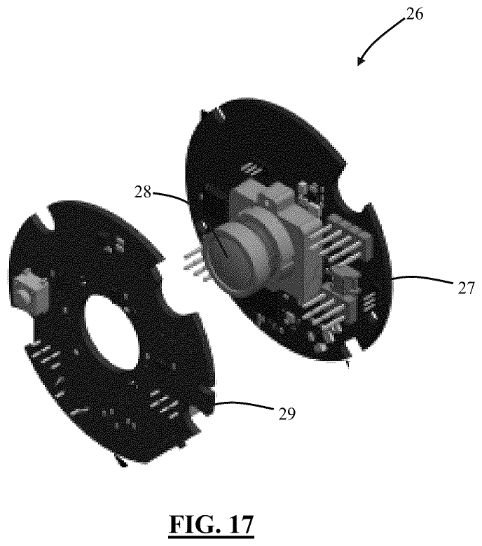

FIGS. 15 and 16 show an imaging assembly 8. The imaging assembly 8 includes a mounting bracket 99. Retained on the bracket 99 is a transmitter 101 (e.g., antenna). The bracket 99 includes a shelf 103 upon which the transmitter 101 is located on. Affixed to the mounting bracket 99 is also a camera module 26 (not shown in its entirety). The camera module 26 includes a lens 28. An exemplary camera module 26 may be depicted in FIG. 17.

FIG. 17 shows a camera module 26. The camera module 26 may include a camera-sensor board 27. The camera module 26 may include a camera infrared board 29. The camera module 26 includes a lens 28. The camera module 26 can also include or be a printed circuit board (PCB) with each of the components of the camera.

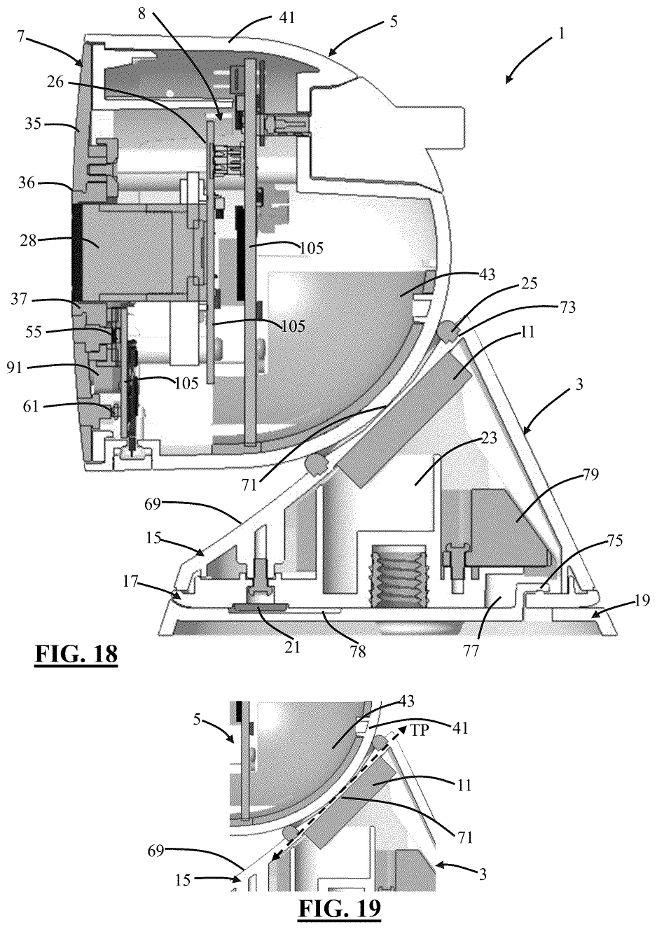

FIG. 18 shows a camera assembly 1.

The camera assembly 1 includes a base assembly 3. The base assembly 3 includes a wall mount 19. The wall mount 19 includes one or more foot depressions 78. One or more feet 21 of a base bottom 17 rest within the one or more foot depressions 78. The wall mount 19 includes one or more tabs 75. The one or more tabs 75 are slidably inserted into one or more tab openings 77 of the base bottom 17.

The base bottom 17 includes a magnet holder 23. About the magnet holder 23 are one or more weights 79. Retained by the magnet holder 23 is a magnet 11. The magnet 11 is located such as to be under and adjacent to an upper surface 69 of a base shell 15. Located on the base shell 15 is a friction ring 25. Defined within the interior of the friction ring 25 is a mating area 71. The friction ring 25 rests inside of a friction depression 73. The mating area 71 has less contact with the housing 41 as compared to the friction ring 25. The mating area 71 has substantially tangential contact with the contour of the housing 41.

The camera assembly 1 includes a housing assembly 5. The housing assembly 5 includes a housing 41. Inside of the housing 41 is a metallic liner 43. The metallic liner 43 is attracted by the magnet 11 such as to hold the housing assembly 5 affixed to the base assembly 3. Inside of the housing assembly 5 is an imaging assembly 8. The imaging assembly 8 includes a camera module 26. The camera module 26 includes a lens 28. The imaging assembly 8 may include one or more circuit boards 105.

The camera assembly 1 includes a face assembly 7. The face assembly 7 includes cover 35. The face assembly 7 includes a lens opening 36. In the lens opening is a lens 28. Sealing about the lens 28 is a seal 37. One or more sensors 55, light sources 61, and/or even microphones 91 may be mounted to a circuit board 105.

FIG. 19 illustrates a close-up cross-section of the camera assembly 1. The magnet 11 may be at a tangential angle relative to the housing 41, the metallic liner 43, or both. An upper surface of the magnet 11 may be substantially planar. An upper surface of the magnet 11 may be parallel and/or be located in a tangent plane TP. The tangent plane TP may be a plane which is tangent to the curved outer surface of the housing 41.

### REFERENCE NUMBER LIST

1 Camera assembly
3 Base assembly
5 Housing assembly
7 Face assembly
8 Imaging assembly
9 Power adapter
11 Magnet
15 Base shell
17 Base bottom
19 Wall mount
21 Feet
23 Magnet holder
24 Notch
25 Friction ring
26 Camera module
27 Camera-sensor board
28 Lens
29 Camera IR board
35 Cover
36 Lens opening
37 Seal
41 Housing
43 Metallic liner
45 Opening(s) of housing
47 Button
49 Reset button
51 Memory card cover
55 Sensor
57 Light sensor
58 Ambient light sensor (ALS)
59 Sensor opening
61 Light source
62 Light emitting diode (LED)
63 Light opening
65 Microphone opening(s)
67 Speaker opening(s)
69 Upper surface
71 Mating area
73 Friction depression
75 Tab
76 Fastener opening
77 Tab opening
78 Foot depression
79 Weight
81 Mount adapter
83 Adhesive
85 Tape
87 Gasket
89 Seal bracket
91 Microphone
93 Speaker
95 Speaker bracket
97 Foam
99 Mounting bracket
101 Transmitter
103 Shelf (of bracket)
105 Circuit board
VA Vertical Axis
MS Magnet Surface
θ Magnet Angle
TP Tangent plane

Unless otherwise stated, any numerical values recited herein include all values from the lower value to the upper value in increments of one unit provided that there is a separation of at least 2 units between any lower value and any higher value. As an example, if it is stated that the amount of a component, a property, or a value of a process variable such as, for example, temperature, pressure, time and the like is, for example, from 1 to 90, preferably from 20 to 80, more preferably from 30 to 70, it is intended that intermediate range values such as (for example, 15 to 85, 22 to 68, 43 to 51, 30 to 32 etc.) are within the teachings of this specification. Likewise, individual intermediate values are also within the present teachings. For values that are less than one, one unit is considered to be 0.0001, 0.001, 0.01, or 0.1 as appropriate. These are only examples of what is specifically intended, and all possible combinations of numerical values between the lowest value and the highest value enumerated are to be considered to be expressly stated in this application in a similar manner.

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The terms “generally” or “substantially” to describe angular measurements may mean about +/−10° or less, about +/−5° or less, or even about +/−1° or less. The terms “generally” or “substantially” to describe angular measurements may mean about +/−0.01° or greater, about +/−0.1° or greater, or even about +/−0.5° or greater. The terms “generally” or “substantially” to describe linear measurements, percentages, or ratios may mean about +/−10% or less, about +/−5% or less, or even about +/−1% or less. The terms “generally” or “substantially” to describe linear measurements, percentages, or ratios may mean about +/−0.01% or greater, about +/−0.1% or greater, or even about +/−0.5% or greater.

The disclosures of all articles and references, including patent applications and publications, are incorporated by reference for all purposes. The term “consisting essentially of” to describe a combination shall include the elements, ingredients, components, or steps identified, and such other elements ingredients, components, or steps that do not materially affect the basic and novel characteristics of the combination. The use of the terms “comprising” or “including” to describe combinations of elements, ingredients, components, or steps herein also contemplates embodiments that consist essentially of, or even consist of the elements, ingredients, components, or steps. Plural elements, ingredients, components, or steps can be provided by a single integrated element, ingredient, component, or step. Alternatively, a single integrated element, ingredient, component, or step might be divided into separate plural elements, ingredients, components, or steps. The disclosure of “a” or “one” to describe an element, ingredient, component, or step is not intended to foreclose additional elements, ingredients, components, or steps.

It is understood that the above description is intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

What is claimed is:

1. A camera assembly comprising:
a) a housing assembly having:
i) a housing;
ii) an imaging assembly within the housing; and
iii) one or more metallic liners within the housing and which have a shape at least partially reciprocal with a shape of an interior of the housing; and
b) a base assembly having:
i) a friction member adapted to have the housing assembly resting thereon and adapted to resist movement of the housing assembly relative to the base assembly;
wherein the friction member has a shape which is substantially a ring, torus, cylinder, or a combination thereof, and
wherein the friction member defines a mating area between the housing assembly and the base assembly;
ii) a magnet therein and coaxially aligned with the friction member;
wherein the magnet is configured to be magnetically attracted to the one or more metallic liners to removably and movably support the housing assembly on the base assembly; and
wherein the magnet is retained at an angle such that an upper surface of the magnet is parallel to a tangent plane which is tangential to an outer curvature of the housing and the angle is offset from a vertical axis.

2. The camera assembly of claim 1, wherein the magnet is has a shape which is substantially a cylinder, ring, torus, or a combination thereof; and
wherein the magnet is substantially solid or includes a void therethrough.

3. The camera assembly of claim 1, wherein the angle is about 10 degrees to about 80 degrees relative to the vertical axis.

4. The camera assembly of claim 1, wherein the base assembly includes a base bottom affixed to a base shell and the magnet is located between the base bottom and the base shell; and
wherein the base bottom includes a magnet holder which projects upward from the base bottom toward the base shell and which holds the magnet at the angle.

5. The camera assembly of claim 4, wherein the magnet holder includes a pair of notches formed at a rim and/or an edge of the magnet holder and opposite one another;
wherein each individual notch of the pair of notches includes one or more side walls angled at a same angle as the angle in which the magnet is retained; and
wherein the magnet is seated within the one or more notches and rests on the one or more side walls.

6. The camera assembly of claim 5, wherein one or more weights are located inside of the base assembly between the base shell and the base bottom.

7. The camera assembly of claim 5, wherein the base shell includes an upper surface which is a surface configured to be in proximity to the housing assembly.

8. The camera assembly of claim 7, wherein the upper surface includes a friction depression which is formed as a groove in the upper surface of the base shell and which has a shape substantially reciprocal to a shape of a friction member.

9. The camera assembly of claim 1, wherein the friction member contacts a greater surface area of the housing than the mating area.

10. The camera assembly of claim 9, wherein the mating area has substantially tangential contact with the housing.

11. The camera assembly of claim 1, wherein the housing has a three-dimensional shape which is substantially a half-capsule, half-sphere, pyramid, cube, cuboid, prism, cone, cylinder, sphere, or any combination thereof.

12. The camera assembly of claim 1, wherein the housing includes a plurality of speaker openings arranged in a plurality of arrays and which are located toward and/or at a rear, side, or both of the housing.

13. The camera assembly of claim 1, wherein the housing includes an opening for a power plug which is located toward a rear and opposite a rim of the housing.

14. The camera assembly of claim 1, wherein the one or more metallic liners have a shape at least partially reciprocal with a shape of a rear, a bottom, and/or a side of the interior of the housing.

15. The camera assembly of claim 14, wherein the one or more metallic liners individually or together have a shape which is substantially a partial capsule, partial sphere, partial cube, partial cuboid, partial cylinder, partial cone, or any combination thereof.

16. The camera assembly of claim 1, wherein the one or more metallic liners comprise one or more metals which are one or more ferromagnetic metals.

17. The camera assembly of claim 1, wherein the camera assembly includes one or more light sensors, one or more light sources, and one or more microphones.

18. The camera assembly of claim 1, wherein the camera assembly includes a face assembly configured to cover the housing assembly;
wherein the face assembly includes a cover affixed at a front of the housing;
wherein the cover includes a lens opening through which a lens passes through; and
wherein the face assembly includes a seal which is located about the lens and in the lens opening; and
wherein the cover is convex and projects away from the housing.

19. The camera assembly of claim 18, wherein the cover includes a plurality of openings; and wherein plurality of openings includes:
a) a lens opening aligned with the lens;
b) one or more sensor openings aligned with one or more sensors;
c) one or more light openings aligned with one or more light sources; and
d) one or more microphone openings aligned with one or more microphones.

20. A camera assembly comprising:
a) a housing assembly having:
i) a housing;
ii) an imaging assembly within the housing; and
iii) one or more metallic liners within and biased toward a rear of the housing and
which have a shape at least partially reciprocal with a shape of the housing; and
b) a base assembly having:
i) a base shell;
ii) a friction member adapted to have the housing resting thereon and adapted to resist movement of the housing assembly relative to the base assembly;
wherein the friction member defines a mating area between the housing assembly and the base assembly; and
wherein the friction member has a shape which is substantially a ring, torus, cylinder, or a combination thereof;
iii) a base bottom affixed to the base shell and defining an interior of the base assembly;
iv) a magnet holder which projects upward from the base bottom toward the base shell and having a pair of notches formed at a rim;
v) a magnet retained by the magnet holder within the pair of notches and located between the base shell and the base bottom;
wherein the magnet is configured to be magnetically attracted to the one or more metallic liners to removably and moveably support the housing assembly on the base assembly;
wherein the magnet has a shape which is substantially a cylinder, ring, torus, or a combination thereof;
wherein the magnet is substantially coaxially aligned with the friction member;
wherein the magnet is retained at an angle by the pair of notches such that an upper surface of the magnet is parallel to a tangent plane which is tangential to an outer curvature of the housing; and
wherein the angle of the upper surface of the magnet is offset from a vertical axis by about 10 degrees to about 80 degrees.
